(19) United States
(12) Patent Application Publication
(10) Pub. No.: US 2021/0219670 A1
(43) Pub. Date: Jul. 22, 2021

(54) Loops component of hook-and-loop fastener

(71) Applicant: Chi-Jung Wang, New Taipei City (TW)

(72) Inventor: Chi-Jung Wang, New Taipei City (TW)

(21) Appl. No.: 17/225,152

(22) Filed: Apr. 8, 2021

(51) Int. Cl. A44B 18/00

(52) U.S. Cl. CPC A44B 18/0057

(57) ABSTRACT

A loops component of a hook-and-loop fastener includes an outer fabric; an inner membrane surrounded by the outer fabric; and a foam layer disposed in the inner membrane which is formed of thermoplastic. The thermoplastic is thermoplastic polyurethane (TPU), thermoplastic polyolefin (TPO), ethylene-vinyl acetate (EVA), polyester, nylon or polyurethane (PU).

### BACKGROUND OF THE INVENTION

### 1. Field of the Invention

The invention relates to hook-and-loop fasteners and more particularly to a loops component of a hook-and-loop fastener having improved characteristics.

### 2. Description of Related Art

A hook-and-loop fastener comprises a first component of a lineal fabric strip which is attached to the opposing surfaces to be fastened of a second component of a lineal fabric strip. The first component features tiny hooks and the second features smaller loops. When the two components are pressed together the hooks catch in the loops and the two components fasten temporarily. When separated, by pulling or peeling the two surfaces apart, the strips make a distinctive “ripping” sound.

However, conventional hook-and-loop fasteners are disadvantageous because they are made of rigid material, uneven or toothed sides of the hooks and loops components which may hurt the hand if sufficient care is not taken in use, and the hooks are required to attach to the loops along a set direction, otherwise the fastening may be compromised.

Thus, the need for improvement still exists.

### SUMMARY OF THE INVENTION

It is therefore one object of the invention to provide a loops component of hook-and-loop fastener comprising an outer fabric; an inner membrane; and a foam layer in the inner membrane.

The above and other objects, features and advantages of the invention will become apparent from the following detailed description taken with the accompanying drawings.

### BRIEF DESCRIPTION OF THE DRAWINGS

FIG. 1 is a perspective view of a half-finished loops component of hook-and-loop fastener according to the invention;

FIG. 2 is a perspective view of the finished loops component;

FIG. 3 is a flowchart of a process of manufacturing a loops component of hook-and-loop fastener according to the invention; and

FIG. 4 is a perspective view of a half-finished loops component of hook-and-loop fastener in the sub-step of S7.

### DETAILED DESCRIPTION OF THE INVENTION

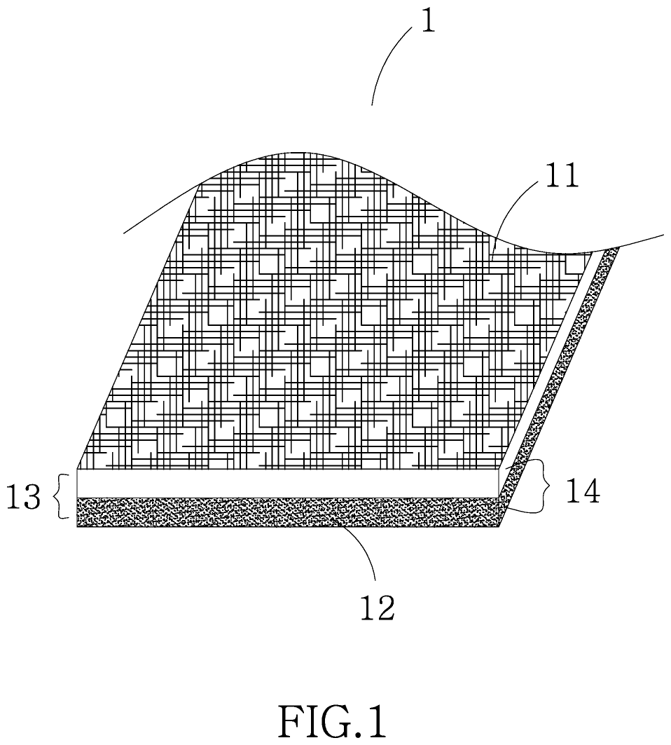

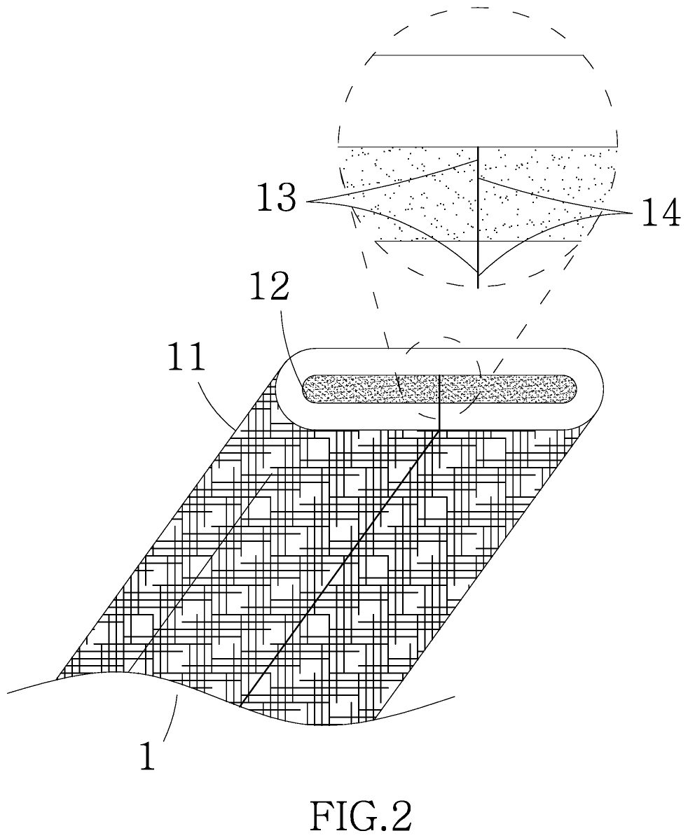

Referring to FIGS. 1 to 2, a loops component 1 of hook-and-loop fastener in accordance with the invention comprises an outer fabric 11 and an inner membrane 12. A left side 13 and a right side 14 of the loops component 1 are joined to form the outer fabric 11 and the inner membrane 12. That is, the loops component 1 has both top and bottom formed of the fabric 11. Both the fabric 11 and the membrane 12 are flexible and extendable. The membrane 12 is made of thermoplastic such as thermoplastic polyurethane (TPU), thermoplastic polyolefin (TPO), ethylene-vinyl acetate (EVA), polyester, nylon or polyurethane (PU).

It is envisaged by the invention that the loops component 1 is flexible and extendable. Sides of the loops component 1 are soft and an individual may have a feeling of comfortable when holds it. Top and bottom surfaces of the loops component 1 can be attached to the hooks component, resulting in a convenient use.

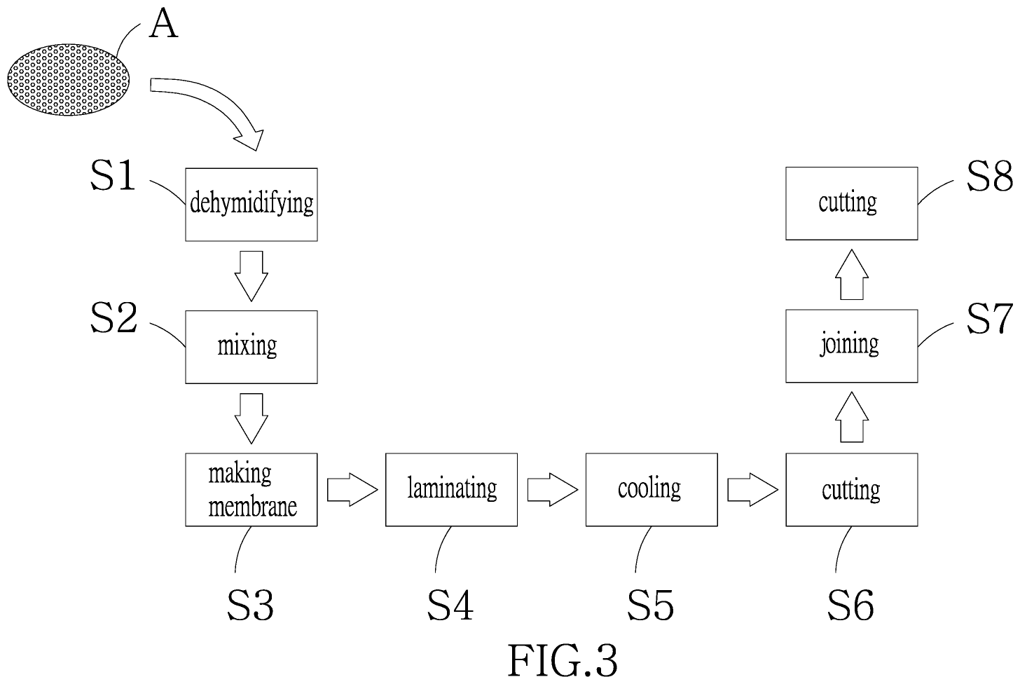

Referring to FIG. 3, a flow chart of a process of manufacturing a loops component of hook-and-loop fastener in accordance with the invention is illustrated. The process comprises the steps of: (S1) placing a thermoplastic material A in a dehumidifier controlled at 40-130° C. for 6 hours to remove water from the thermoplastic material A; (S2) mixing the thermoplastic material A in a mixing device controlled at 60-280° C. for 30 seconds to 5 minutes to form a liquid substance; (S3) transferring the liquid substance to a membrane making device and activating the membrane making device controlled at 50-80° C. for 1 to 3 minutes to make a continuous membrane; (S4) placing the continuous membrane on a top surface of a fabric and heating a laminating device controlled at 50-250° C. for 0.1 to 180 seconds to form a loops component by sticking the continuous membrane and the fabric together; (S5) removing the loops component from the laminating device and placing same in a cooling device controlled at 5-60° C. for 0.01 to 180 seconds to form a solid loops component; (S6) transferring the solid loops component to a cutting device to cut the solid loops component into a plurality of loops components having a predetermined width; (S7) activating a heating device controlled at 50-250° C. for 0.01 to 120 seconds to join left and right sides of the loops component to form a loops component having an outer fabric and an inner membrane; and (S8) removing the loops component from the heating device and activating the cutting device to cut the loops component into a plurality of finished loops components having a predetermined width.

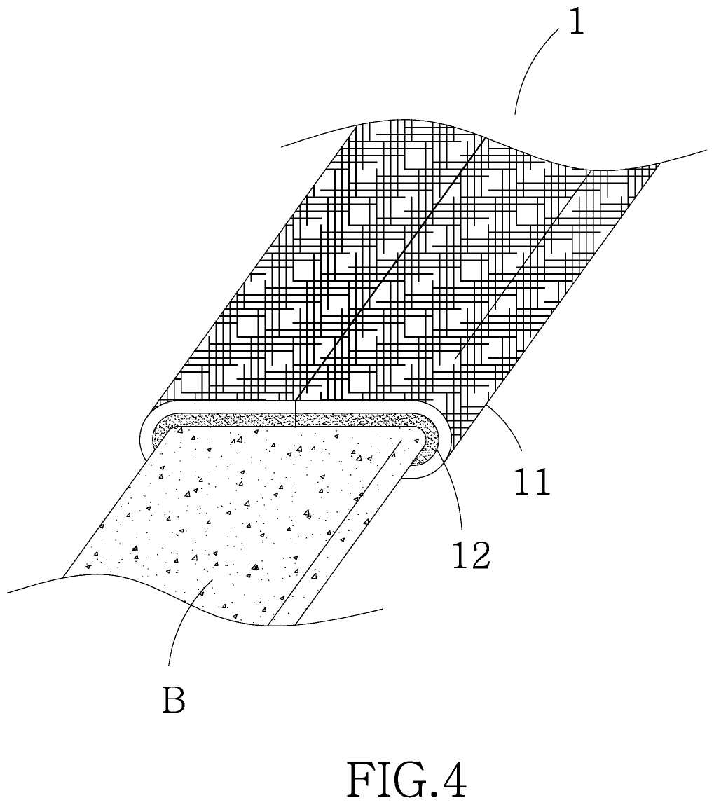

Referring to FIG. 4 in conjunction with FIGS. 1 and 2, step (S7) further comprises the sub-step of placing a foam material on the top surface of the loops component and joining left and right sides of the loops component to form a loops component 1 having an outer fabric 11, an inner membrane 12, and a foam layer B in the inner membrane 12. The loops component 1 has increased padding capability.

While the invention has been described in terms of preferred embodiments, those skilled in the art will recognize that the invention can be practiced with modifications within the spirit and scope of the appended claims.

What is claimed is:

1. A loops component of hook-and-loop fastener, comprising:
an outer fabric;
an inner membrane surrounded by the outer fabric; and
a foam layer disposed in the inner membrane.

2. The loops component of hook-and-loop of claim 1, wherein the inner membrane is formed of thermoplastic.

3. The loops component of hook-and-loop of claim 2, wherein the thermoplastic is TPU, TPO, EVA, polyester, nylon or PU.
